(19) United States
(12) Patent Application Publication
(10) Pub. No.: US 2011/0258326 A1
(43) Pub. Date: Oct. 20, 2011

(54) METHOD, DEVICE, AND SYSTEM FOR IMPLEMENTING RESOURCE SHARING

(76) Inventors: Lixin HU, Shenzhen (CN); Hongqing Bao, Shenzhen (CN)

(21) Appl. No.: 13/173,467

(22) Filed: Jun. 30, 2011

Related U.S. Application Data
(63) Continuation of application No. PCT/CN2009/076170, filed on Dec. 29, 2009.

(30) Foreign Application Priority Data
Dec. 31, 2008 (CN) 200810246811.4

(51) Int. Cl. G06F 15/173; H04L 29/06

(52) U.S. Cl. 709/226; 726/3

(57) ABSTRACT

A method, a device, and a system for implementing resource sharing through a user management device are provided. The method includes: saving shared resource information shared by a shared resource provision user with a shared resource access user in the user management device; and when the shared resource access user accesses shared resource, generating, by the user management device, identification information for accessing the shared resource according to the shared resource information and an application key, and sending the identification information to the shared resource access user, where if the shared resource access user accesses the shared resource on a resource management device according to the identification information for accessing the shared resource, the resource management device is capable of verifying the identification information for accessing the shared resource by using the application key

### CROSS-REFERENCE TO RELATED APPLICATIONS

This application is a continuation of International Application No. PCT/CN2009/076170, filed on Dec. 29, 2009, which claims priority to Chinese Patent Application No. 200810246811.4, filed on Dec. 31, 2008, both of which are hereby incorporated by reference in their entireties.

### FIELD OF THE INVENTION

The present invention relates to the field of network communications technologies, and in particular, to a technology for managing network resources.

### BACKGROUND OF THE INVENTION

With the fast development of the Internet, a Social Network Service (SNS) platform also provides an Application Program Interface (API), so that other websites can obtain the functions provided by the SNS platform or apply resources on the SNS platform through the API, or a user of the SNS platform can share his/her various resources on some application websites with his/her friends through the API.

For example, the user of the SNS platform can share his/her photo resources on an application website for providing an album function with his/her friends on the SNS platform. The specific process is as follows: The application website for providing the album function sends a photo sharing message to friends of the user on the SNS platform, and then the friends can access the photo resources shared by the user by clicking a link in the sharing message, but other persons cannot access the photo resources.

In the implementation of the present invention, the inventors finds that: To ensure that the user of the SNS platform can securely share resources on each application website, the resource sharing process of application websites needs to be protected, so that only a friend approved by the user of the SNS platform has the rights to access the shared resources on the application websites.

In the prior art, however, if the friend provides the link in the sharing message to other users, other users can also access the resources on the application websites. In this case, the user on the SNS platform cannot securely share his/her resources on the application websites.

### SUMMARY OF THE INVENTION

Embodiments of the present invention provide a method, a device, and a system for implementing resource sharing, so that a user on a user management device can securely share a resource on a resource management device.

A method for implementing resource sharing is provided, where the method includes:
saving, in a user management device, shared resource information shared by a shared resource provision user with a shared resource access user, where the shared resource information is used to identify the shared resource access user having a right to access a shared resource and the shared resource provided by the shared resource provision user in a resource management device; and
generating, by the user management device, identification information for accessing the shared resource according to the shared resource information and an application key, and sending the identification information to the shared resource access user when the shared resource access user accesses the shared resource, where the shared resource access user is capable of accessing the shared resource in the resource management device according to the identification information for accessing the shared resource, and the resource management device is capable of verifying the identification information for accessing the shared resource by using the application key.

A user management device is provided, where the device includes:
a shared resource information storing unit, configured to save shared resource information shared by a shared resource provision user with a shared resource access user, where the shared resource information is used to identify the shared resource access user having a right to access a shared resource and the shared resource locally provided by the shared resource provision user;
an identification information generating unit, configured to generate identification information for accessing the shared resource according to the shared resource information saved in the shared resource information storing unit and an application key when the shared resource access user accesses the shared resource, where the shared resource access user is capable of accessing the shared resource in a resource management device according to the identification information for accessing the shared resource, and the resource management device is capable of verifying the identification information for accessing the shared resource by using the application key; and
an identification information sending unit, configured to send the identification information generated by the identification information generating unit to the shared resource access user.

A method for implementing resource sharing is provided, where the method includes:
obtaining, by a resource management device, a link for accessing a shared resource sent by a shared resource access user, where the link for accessing the shared resource is determined according to identification information for accessing the shared resource, the identification information for accessing the shared resource is generated according to shared resource information and an application key, and the shared resource information is used to identify the shared resource access user having a right to access the shared resource and the shared resource provided by a shared resource provision user in the resource management device; and
verifying, by the resource management device, the link for accessing the shared resource according to the application key, so as to control the right for the shared resource access user to access the shared resource.

A resource management device is provided, where the device includes:
a link obtaining unit, configured to obtain a link for accessing a shared resource sent by a shared resource access user, where the link for accessing the shared resource is determined according to identification information for accessing the shared resource, the identification information for accessing the shared resource is generated according to shared resource information and an application key, and the shared resource information is used to identify the shared resource access user having a right to access the shared resource and the shared resource provided by a shared resource provision user in the resource management device; and
a verification processing unit, configured to verify the link for accessing the shared resource according to the application key obtained by the link obtaining unit, so as to control the right for the shared resource access user to access the shared resource.

A system for implementing resource sharing is provided, which includes the user management device and the resource management device.

It can be seen that the technical solutions provided by the embodiments of the present invention can securely implement a resource sharing service for the user on the user management device, therefore ensuring that the shared resource provision user can efficiently control the process for sharing the shared resource provided by the shared resource provision user, and efficiently preventing a shared resource access user without an access right from accessing the shared resource.

### BRIEF DESCRIPTION OF THE DRAWINGS

To illustrate the technical solutions according to the embodiments of the present invention more clearly, the accompanying drawings for describing the embodiments are introduced briefly in the following. Apparently, the accompanying drawings in the following description are only some embodiments of the present invention, and persons of ordinary skill in the art can derive other drawings from the accompanying drawings without creative efforts.

FIG. 1 is a schematic diagram of a process for saving shared resource information according to an embodiment of the present invention;

FIG. 2 is a schematic diagram of a process for generating a sharing message according to an embodiment of the present invention;

FIG. 3 is a schematic diagram of a process for accessing a shared resource according to an embodiment of the present invention;

FIG. 4 is a schematic diagram of a process for implementing resource sharing according to an embodiment of the present invention;

FIG. 5 is a schematic diagram of a process of resource sharing based on an access ticket according to an embodiment of the present invention; and

FIG. 6 is a schematic structural diagram of a device and a system according to an embodiment of the present invention.

### DETAILED DESCRIPTION OF THE EMBODIMENTS

The technical solutions of the embodiments of the present invention are described in the following clearly with reference to the accompanying drawings. Apparently, the embodiments in the following descriptions are merely a part of the embodiments of the present invention, rather than all the embodiments of the present invention. Persons of ordinary skill in the art can derive other embodiments based on the embodiments of the present invention without creative efforts, and such derived embodiments all fall within the protection scope of the present invention.

In the technical solutions for implementing resource sharing through a user management device provided by the embodiments of the present invention, shared resource information shared by a shared resource provision user with a shared resource access user needs to be saved in the user management device, where the shared resource information is used to identify the shared resource access user having a right to access a shared resource and the shared resource provided by the shared resource provision user in a resource management device, that is, it can be determined which shared resource access users can access the shared resource according to the shared resource information. In this way, when the shared resource access user accesses the shared resource, the user management device can generate identification information for accessing the shared resource according to the shared resource information and an application key and send the identification information to the shared resource access user, so that the shared resource access user is capable of accessing the shared resource on the resource management device according to the identification information for accessing the shared resource to implement the resource sharing, and the resource management device is capable of verifying the identification information for accessing the shared resource by using the corresponding application key to ensure the security in the corresponding resource sharing process.

The application key can be pre-saved on the user management device and/or the resource management device, obtained from a credible third party when the user management device and/or the resource management device requires the application key, or generated by the user management device and/or the resource management device according to a predetermined rule. The application key is shared by the user management device and the resource management device, and other devices cannot know the application key.

In the preceding process, the shared resource provision user can specifically access the user management device through a sharing link or an application page in an embedded frame provided by the resource management device and notify one or more shared resource access users that can access the shared resource selected by the shared resource provision user to the user management device; after obtaining the shared resource access user selected by the shared resource provision user, the user management device can generate the corresponding shared resource information according to the shared resource access user selected by the shared resource provision user and the shared resource provided by the shared resource provision user for sharing. In the process of notifying the one or more shared resource access users to the user management device, identifier (ID) information of the one or more shared resource access users can be sent to the user management device, or if the shared resource provision user wishes that all users in a group can access the shared resource, a group ID of a group including the one or more shared resource access users can also be sent to the user management device. The user management device can specifically determine the shared resource provided by the shared resource provision user for sharing through the sharing link or the application page in the iframe adopted by the shared resource provision user.

In the embodiments of the present invention, the corresponding shared resource information may include an application ID for identifying the resource management device, an application resource ID for identifying the resource, and shared resource access user information; or include the application resource ID for identifying the resource and the shared resource access user information. Optionally, the shared resource information may also include a resource type indicating whether the shared resource is a public resource or a private resource. The shared resource access user information may be ID information of one or more accessors. The access user is a shared resource access user or a group including one or more shared resource access user.

Optionally, in the embodiments of the present invention, the identification information for accessing the shared resource sent to the shared resource access user can specifically be generated by adopting any one of the following modes.

Mode 1: A security authentication parameter is generated according to the shared resource information and the application key, a link for accessing the shared resource is generated by employing the security authentication parameter, and the link for accessing the shared resource is taken as the identification information for accessing the shared resource that needs to be sent to the shared resource access user.

Mode 2: An access ticket is generated according to the shared resource information and the application key, and the access ticket is taken as the identification information for accessing the shared resource that needs to be sent to the shared resource access user, where the access ticket can specifically be taken as a basis for the shared resource access user to generate a link for accessing the shared resource. Specifically, the shared resource access user can generate a security authentication parameter according to the access ticket first, and then generate the link for accessing the shared resource according to the security authentication parameter.

To further verify the link for accessing the shared resource and increase the security in the resource sharing process, the corresponding link for accessing the shared resource further includes at least one of a valid time parameter for indicating valid time information of the link for accessing the shared resource and address information of the shared resource access user. In this way, when obtaining the access performed through the link for accessing the shared resource, the resource management device can further verify whether the access to the shared resource is valid according to at least one of the valid time parameter and the address information of the shared resource access user.

In the embodiments of the present invention, because the shared resource may be a public resource, the user management device may also identify the resource type of the shared resource provided by the shared resource provision user in the resource management device. If the shared resource is a public resource, because the security problem of the sharing does not need to be considered for the public resource, the link for accessing the shared resource can be generated directly and provided to the shared resource access user. Only if the shared resource is a private resource, the identification information for accessing the shared resource is generated according to the shared resource information and the application key, and then the subsequent procedure for accessing the shared resource continues.

Optionally, in the embodiments of the present invention, the user management device may also generate a pre-access link, and generate the identification information for accessing the shared resource according to the shared resource information and the application key after the user clicks the pre-access link, and then the subsequent procedure for accessing the shared resource continues. Specifically, the process may be as follows: First, the user management device sends a sharing message to the shared resource access user, where the sharing message includes a link for processing resource sharing pointed to the user management device; then, the shared resource access user obtains the sharing message and accesses the user management device through the link for processing resource sharing, and after verifying that the pre-access link (that is, the link for processing resource sharing) is generated by the user management device, the user management device generates the identification information for accessing the shared resource. Through the corresponding pre-access link, in the case that the generated identification information for accessing the shared resource includes a valid period parameter, it can be effectively prevented that the identification information for accessing the shared resource is invalid because the user does not apply the identification information for accessing the shared resource in time and the shared resource cannot be accessed.

The user management device may be a device including a plurality of managed users or groups, such as a social platform. The corresponding resource management device may be any apparatus or device providing resource management, such as an application website.

In the case that the social platform is taken as an example of the user management device and the application website is taken as an example of the resource management device, the process for the shared resource provision user to share the resource on the application website may be as follows: The shared resource provision user clicks a sharing link in the application website and then a social platform page is displayed, or the shared resource provision user browses an application page displaying the social platform page in the embedded frame; if the shared resource provision user does not log in to the social platform, a social platform login page can be displayed on the social platform page, so that the shared resource provision user can log in to the social platform. After the login operation, a user browser applied by the shared resource provision user obtains a friend list and groups of the social platform and displays them to the shared resource provision user; then the shared resource provision user selects a friend or a group as the shared resource access user and submits the shared resource access user to the social platform, so that the social platform saves the shared resource information.

When the shared resource access user accesses the shared resource, the shared resource access user first makes a request for viewing the sharing message. At this time, the social platform generates the sharing message sent to the shared resource access user according to the shared resource information. The shared resource access user clicks the link for processing resource sharing included in the sharing message, and the subsequent process for accessing the shared resource shared by a friend is continued and the process for the application website to authenticate an access right of the shared resource access user is implemented. This guarantees that only the shared resource access user authenticated successfully can access the shared resource shared by the shared resource provision user on the application website.

In the preceding process, after the user management device generates the identification information for accessing the shared resource according to the shared resource information and the application key and sends the identification information to the shared resource access user, the shared resource access user can access the resource management device through the identification information for accessing the shared resource. Specifically, the shared resource access user can access the resource management device through the link for accessing the shared resource corresponding to the identification information for accessing the shared resource, or through the link for accessing the shared resource generated according to the identification information for accessing the shared resource. The resource management device obtains the link for accessing the shared resource sent by the shared resource access user and verifies the link for accessing the shared resource according to the application key, so as to control the right of the shared resource access user to access the shared resource.

Optionally, if the link for accessing the shared resource further includes at least one of the valid time parameter for indicating the valid time information of the link for accessing the shared resource and the address information of the shared resource access user, the resource management device can also verify the link for accessing the corresponding shared resource according to the valid time parameter and the address information.

Taking the application website as an example, in the implementation of the embodiments of the invention, the application website can add the sharing link directly on its own web page or add a sharing iframe (that is, the application page in the iframe). Including an application ID and an application resource ID, a URL of the sharing link or a URL of the sharing iframe is the URL pointed to the social platform, and provided by the social platform to the shared resource provision user to use.

The application website also provides the social platform with an URL of the shared resource for sharing and a mode for accessing the shared resource. For example, a mode that the URL of the shared resource for sharing includes the application resource ID and the security authentication parameter can be adopted to access the shared resource.

The authentication between the application website and the social platform can be implemented by appointing the public key determined in advance as the application key. The application key may be set for each application ID (that is, each application website providing the shared resource) separately or set for all application IDs uniformly. If the application key is set for each application ID separately, the social platform can specifically save a mapping relation between an application ID and an application key by using an application key table.

It can be seen that, through the technical solutions provided by the embodiments of the present invention, when a user shares a resource on the application website with a friend on the social platform, the corresponding shared resource can be protected, that is, the right of the friend to access the shared resource is effectively managed, so that the friend cannot enable users other than authorized objects to access the shared resource by sending an obtained access link, and therefore it is reliably restricted that only the friend receiving the user sharing message can access the shared resource. In other words, in the embodiments of the present invention, user access can be controlled without exposing user information to the resource management device. When a user accesses the shared resource, the resource management device does not need to communicate with the user management device, so the efficiency of processing the user access is very high. Moreover, a user is supported to use the browser to access the shared resource, so that the user does not need to install dedicated terminal software.

For the convenience of understanding the present invention, the embodiments of the processes for the user on the social platform to share the shared resource on the application website are described by taking the social platform and the application website as examples.

### Embodiment 1

Referring to accompanying figures, the corresponding processes provided by Embodiment 1 may specifically include a process for a social platform to save shared resource information, a process for the social platform to generate a sharing message, a process for a user to view and share a shared resource, and a process for an application website to verify a security authentication parameter in a link sent by the user viewing and sharing the shared resource. Each process is separately described in the following.

### Process 1: The Social Platform Saves the Shared Resource Information.

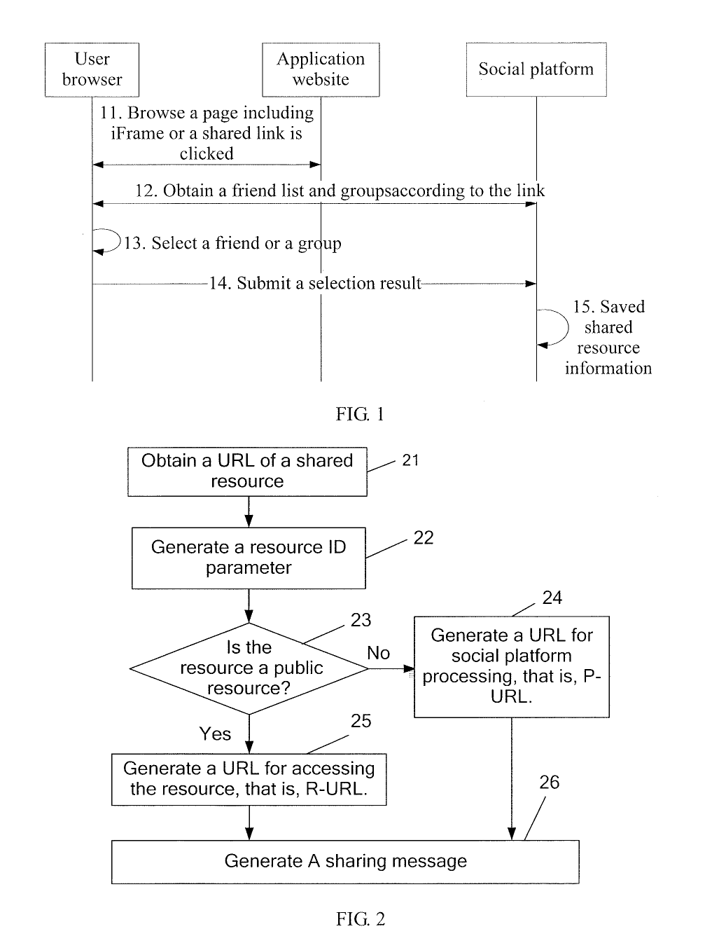

As shown in FIG. 1, the process for the social platform to save the shared resource information may specifically include:

Step 11: During providing the shared resource to be shared on the application website to other users, a user providing the shared resource (that is, a shared resource provision user) needs to click a sharing link on the application website displayed on a user browser or an application page on a social platform page displayed in the iframe, so as to select the shared resource provided for sharing.

The sharing link or the application page in the iframe points to the social platform, and therefore the social platform can obtain an application resource ID for identifying a shared resource on the application website through the sharing link clicked by the shared resource provision user or the application page in the iframe browsed by the shared resource provision user, that is, the social platform can determine the application resource ID corresponding to the shared resource through the process in which the shared resource provision user specifies the shared resource; optionally, the social platform can also obtain at least one of an application ID for identifying the application website and a resource type, where the resource type is used to indicate whether the shared resource is a public resource that does not need to be protected or a private resource that needs to be protected.

Specifically, the application website can provide the application resource ID of the application website in a URL of the sharing link or a URL of the iframe. When the user clicks the link or the browser requests an iframe page, the social platform obtains the URL of the sharing link or the URL of the iframe and the application resource ID in the URL of the sharing link or in the URL of the iframe. Alternatively, the social platform can also be provided with information, such as the application ID and the resource type, through the URL of the sharing link or the URL of the iframe.

Step 12: The shared resource provision user submits a request for obtaining a friend list and groups to the social platform.

Step 13: The shared resource provision user selects a friend or a group as the shared resource access user having an access right according to the friend list and groups returned from the social platform.

Step 14: The shared resource provision user sends a selection result to the social platform through the user browser.

Step 15: The social platform obtains the application resource ID from the information sent by the shared resource provision user and a user capable of accessing the shared resource selected by the shared resource provision user, such as a friend ID and a group ID. Optionally, at least one of the application ID and the resource type may also be obtained.

The social platform saves a sharing record as the shared resource information for each sharing object (that is, the shared resource access user capable of accessing the shared resource). The sharing record may include the sharing object (for example, the shared resource access user having a right to access the shared resource, such as a friend of a user sharing the shared resource or a group that the user participates in) and the application resource ID. Optionally, the sharing record may also include one or more of the application ID for identifying the application website and the resource type.

### Process 2: The Social Platform Generates the Sharing Message.

After logging in to the social platform, a user can query the sharing message generated by the social platform for the user, so as to access the shared resource provided for the user through the sharing message. Therefore, the social platform needs to generate the sharing message for the user.

The social platform can generate the sharing message according to the queried sharing record in which the sharing object is the user and provide the sharing message to the user, so that the user can obtain the sharing message provided by the social platform after logging in to the social platform. Alternatively, the social platform can generate the sharing message according to the queried sharing record in which the sharing object is a group including the user and provide the sharing message to the user, so that the user can obtain the sharing message of the group that the user participates in after logging in to the social platform. Moreover, if a plurality of sharing records exists for the user or the group, one sharing message is generated for each sharing record separately.

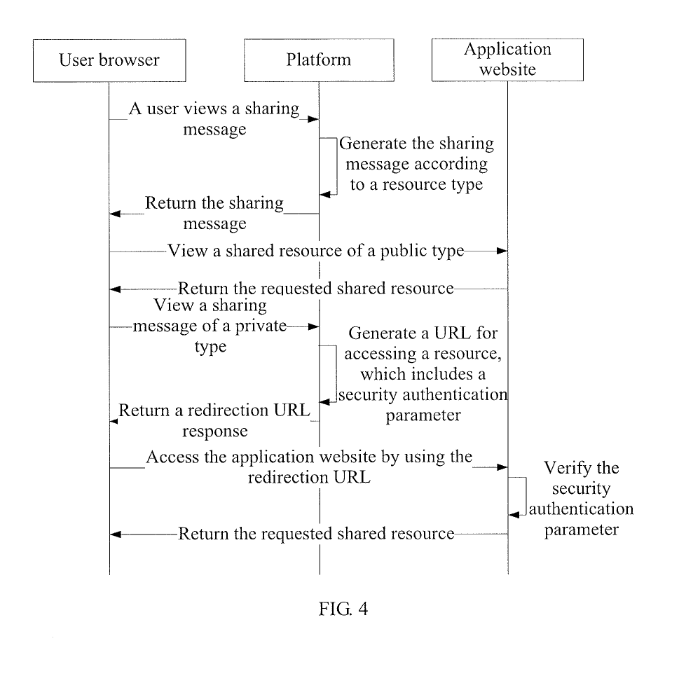

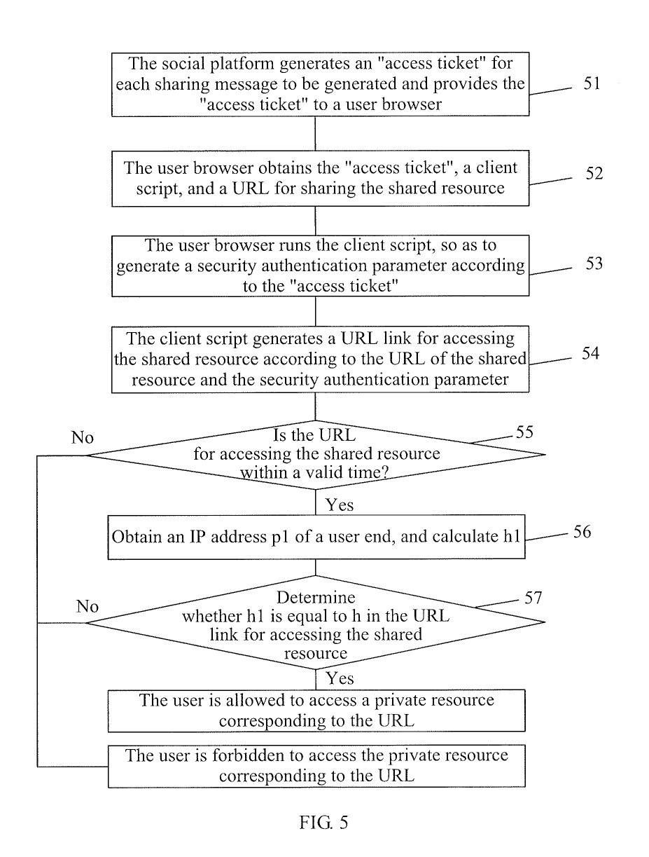

Specifically, the process for the social platform to generate the sharing message is shown in FIGS. 2 and 4 and may include the following steps:

Step 21: The social platform obtains a URL of the shared resource for sharing provided by the application website according to the application ID, where the URL is called a resource URL (S-URL).

Step 22: The application resource ID r is obtained according to the sharing record and a resource ID parameter R=r is generated.

Step 23: Determine a type of the shared resource according to the resource type in the sharing record to generate a URL for accessing the shared resource, where if the resource is a private resource, step 24 is performed; if the resource is a public resource, step 25 is performed.

Step 24: For the private resource, the social platform obtains the application ID a, generates a URL link for processing private resource sharing pointed to the social platform as a URL link for accessing the shared resource (called a private URL link (P-URL): P-URL?APPID=a&R=r&T=t&H=h) according to a determination result in step 23, and performs step 26, where APPID is the application ID.

In the P-URL link, R is a character string for the application website to identify the resource, and is called a resource ID parameter; T denotes whether the resource type of the shared resource is public resource or private resource; a value of H is a hash value h=MD5 (APPID“:”R“:”T“:”APPKEY), that is, a hash value consisting of the application ID, the application resource ID, the resource type, and an application key, where the APPKEY is the application key, which can be determined from the a pre-saved application key table (the pre-saved application key table can pre-save a mapping relation between an application key and an application ID) according to the application ID or generated according to a predetermined rule. In this way, when receiving the URL, the social platform can verify the value of the H to prevent the user from constructing the URL directly, therefore ensuring that the URL is uniquely corresponding to one sharing record.

Step 25: For the public resource, the social platform generates the URL for accessing the shared resource (that is, a public URL link (R-URL): S-URL?R=r) according to the determination result and performs step 26.

Step 26: The social platform generates the sharing message, where the sharing message includes the sharing object and a title obtained from the sharing record and the generated P-URL link or R-URL link.

### Process 3: The Platform Provides the Link for Accessing the Shared Resource.

After obtaining the sharing message, the user can click the link in the sharing message to access a shared application resource (that is, the shared resource).

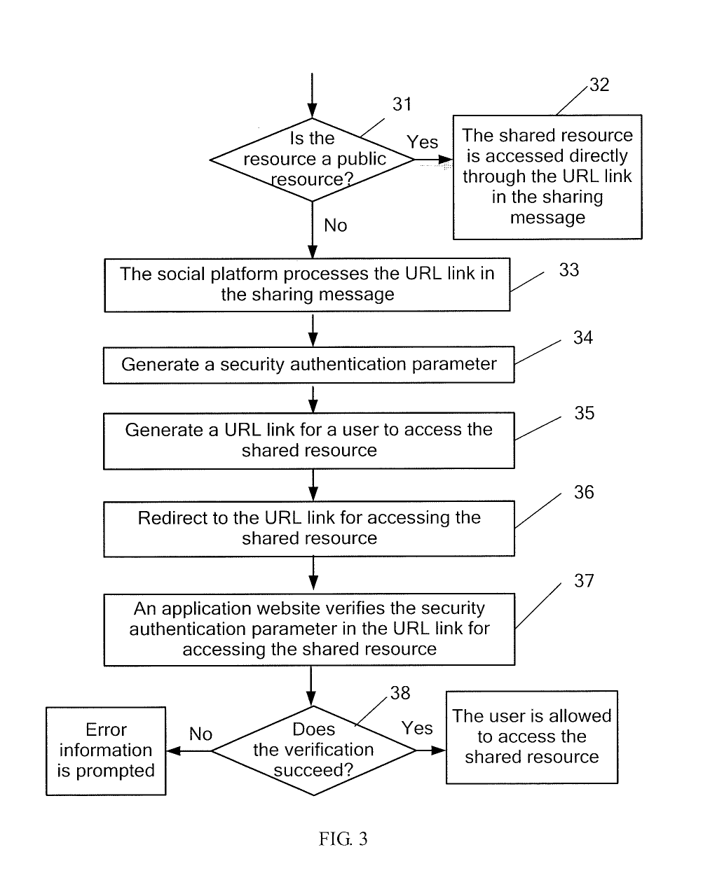

As shown in FIGS. 3 and 4, the process for the user to share the shared resource can be as follows.

Step 31: Determine whether the shared resource is a public resource or a private resource according to information in the sharing message, and if the shared resource is a public resource, step 32 is performed; if the shared resource is a private resource, step 33 is performed.

Step 32: For the public resource, a URL link in the sharing message directly points to the application resource which is used as the shared resource, that is, the user can directly access the shared resource.

Step 33: For the private resource, the link in the sharing message points to the URL link for processing the private resource sharing pointed to the social platform (that is, P-URL), the user sends a request for accessing the shared resource to the social platform through the URL link in the sharing message, and step 34 is performed, where the URL link in the sharing message includes the application ID a, the application resource ID r, the resource type T, and a security parameter H.

Step 34: The social platform can verify whether the H parameter in the URL link is equal to MD5 (APPID“:”R“:”T“:”APPKEY) to verify whether the URL link is generated by the social platform according to the sharing record, so that a URL link constructed by a user can be filtered, where MD5 (APPID“:”R“:”T“:”APPKEY) refers to a value obtained by performing the MD5 algorithm on the application ID APPID, the application resource ID parameter R, the resource type T, and the application key APPKEY.

Step 35: The social platform generates the URL link for the user to access the shared resource, and step 36 is performed.

The process for the social platform to generate the URL link for the user to access the shared resource may include:

First, an Internet Protocol (IP) address value p of a user terminal is obtained; a valid time parameter t is calculated according to an obtained current time t0 and a valid period; a random number n is generated; and the application key k is obtained according to the application ID a included in the URL link in the sharing message. For example, the corresponding application key is determined according to a key table.

Then, a character string S to be hashed, r:t:n:a:k:p, is obtained through combination, a hash value h of the character string S is calculated using the MD5 algorithm, and then a security authentication parameter, T=t&N=n&A=a&H=h, is generated.

Finally, the URL link for accessing the shared resource, S-URL?R=r&T=t&N=n&A=a&H=h, is generated according to the security authentication parameter.

In the process of generating the security authentication parameter, the random number is used to resist plain text attack, the valid time parameter is used to specify the valid period of the generated URL link for accessing the shared resource. When the user uses the URL link to access the application website, the application website checks whether the valid time parameter exceeds the current time, so as to determine the validity of the URL link for accessing the shared resource. An IP address is used to prevent the user from copying the URL link and sending it to others for invalid use.

Step 36: The social platform returns a redirection link (that is, the URL link for accessing the shared resource) to the user browser used by the user: S-URL ?R=r&T=t&N=n& &A=a&H=h.

Step 37: After the user browser accesses the URL link for accessing the shared resource, the application website obtains the URL link and verifies the security authentication parameter in the URL link.

Step 38: Determine whether the verification succeeds, and if the verification succeeds, the user is allowed to access the shared resource specified in the URL link; if the verification fails, the user is forbidden to access the shared resource specified in the URL link and error information may be prompted.

### Process 4: The Application Website Verifies the Security Authentication Parameter in the Link Sent by the User Accessing the Shared Resource.

Specifically, the process for the application website to verify the security authentication parameter in the URL link (that is, the URL link for accessing the shared resource) sent by the user accessing the shared resource may include:
(1) The application website obtains an IP address pl of the user, a current time t1, r, t, and the random number n in the security authentication parameter, the application ID a, and the application key k.

Specifically, the application website can determine the IP address pl of the user according to the URL link sent by the user, obtains the r, t, and random number n from the security authentication parameter carried in the URL link sent by the user, and determines the application ID a according to information locally saved on the application website and then determines the application key k. The application key k can be determined from the pre-saved application key table (the pre-application key table can pre-save the mapping relation between the application key and the application ID) according to the application ID a or generated according to the predetermined rule.
(2) Calculate whether t1 is greater than t, and if t1 is greater than t, the authentication fails and an error message is returned to the user; if t1 is not greater than t, a character string S1 to be hashed is obtained by combining the obtained r, t, n, a, k, and p1, which is r:t:n:a:k:p1, and the MD5 algorithm is performed on the character string S1 to obtain a hash value H1.
(3) Compare the parameter h in the security authentication parameter obtained from the URL link for accessing the shared resource with the calculated parameter H1, and if the two parameters are different, the authentication fails; if the two parameters are the same, the authentication succeeds.

The secure resource sharing can be implemented through Processes 1 to 4, so that the user on the social platform can effectively control the right of sharing the shared resource provided by the user.

### Embodiment 2

In Embodiment 2, if a corresponding shared resource is a private resource, a social platform can also generate a sharing message by adopting another mode, so that a user on the social platform can share the shared resource on an application website.

As shown in FIG. 5, the process for the user on the social platform to share the shared resource on an application website can specifically include the following steps:

Step 51: The social platform generates an “access ticket” for each sharing message to be generated and provides the access ticket to a user browser.

The process for the social platform to generate the “access ticket” may specifically include: First, the social platform obtains an S-URL, a resource ID r, an IP address p of a user end and a current time t0 and then determines a valid time parameter t according to the current time t0 and a valid duration d determined by the social platform (t=t0+d); then, the social platform obtains an application key k according to an application ID a and then generates a character string S=r“:”t“:”a“:”k“:”p; then generates an MD5 abstract data of the character string S (m=MD5(S)), where the MD5(S) refers to information obtained by processing the character string S by adopting the MD5 algorithm. Finally, a parameter set R=r&P=p&T=t&M=m is used as the corresponding “access ticket”.

Step 52: The user browser obtains the “access ticket” and a client script provided by the social platform and the URL of the shared resource for sharing (that is, S-URL) provided by the application website.

Step 53: When the user clicks a sharing message to request accessing the shared resource, the user browser runs the client script, so as to generate a security authentication parameter according to the “access ticket”.

The process for the client script to generate the security authentication parameter may specifically includes: First, the current time t0 is obtained, the valid time parameter t2 is determined according to the valid duration d provided by the social platform, and a parameter T2=t2 is generated, where the parameter T2 can prevent others from stealing the generated URL for accessing the shared resource and using the stolen URL to access the shared resource; then, h=MD5 (t2“:”m) is calculated to generate a parameter H=h, where the parameter H is used to prevent other parameters from being tempered; finally, the parameter set R=r&T=t&T2=t2&H=h is generated as the security authentication parameter.

Step 54: The client script generates a URL link for accessing the shared resource according to the URL of the shared resource for sharing (that is, S-URL) and the security authentication parameter.

Specifically, the generated URL for accessing the shared resource can be S-URL?R=r&P=p&T=t&T2=t2&H=h. The user can access the shared resource on the application website by accessing the URL for accessing the shared resource.

Step 55: The application website obtains the current time t3 after obtaining the URL for accessing the shared resource sent from the user end and checks whether the following condition is met: t3<t2<t; and if the condition is not met, the user is forbidden to access the private resource corresponding to the URL; if the condition is met, step 56 is performed.

Step 56: Obtain the IP address p1 of the user end, and calculate m1=MD5 (r“:”t“:”a“:”k“:”p1) h1=MD5 (t2“:”m1).

Step 57: Determine whether the obtained h1 is equal to h in the URL for accessing the shared resource, and if h1 is equal to h, the user is allowed to access the corresponding private resource; if h1 is not equal to h, the user is refused from accessing the corresponding private resource.

Through Embodiment 2, the user on the social platform can securely share the shared resource on the application website with his/her friends.

The implementation of the present invention is described in the following through a specific application embodiment.

In the specific application embodiment, it is assumed that an application website is Photo.com, a user can manage and share personal photos through the application website, and a corresponding social platform is sns.com. Meanwhile, a friend of a user U on the social website sns.com is a user V, an application ID registered by the application website on sns.com is 123, and a corresponding application key obtained by the application website is 1231234567.

A URL for the application website to process sharing is http://photo.com/share.php. The application website adds a sharing link for a photo browsing page. URL of the photo browsing page is http://photo.com/viewPhoto.php?id=101, and a linked URL is http://sns.com/share.php?appid=123&r=http%3A%2F%2Fphoto.com%2FviewPhoto.php%3Fid%3D101&type=1&title=My%20Boy.

In the linked URL, a value of a parameter r is an encoded URL of the photo browsing page; a parameter “type” denotes a resource type, which specifically adopts 0 to denote a public resource and adopts 1 to denote a private resource; a parameter “title” denotes a sharing title, which is “My Boy” in the linked URL.

Based on the foregoing scene, the process for the user U to share his/her photo resource on the application website Photo.com may specifically include:
(1) The user U clicks the linked URL of the photo browsing page, and then a sharing page is displayed. At this time, if the user U does not log in to sns.com, the displayed page is a login page; if the user U already logs in to sns.com, the displayed page is a page for the user U to select a friend for sharing.
(2) The user U submits the page after selecting the user V.
(3) The social platform sns.com processes data included on the page submitted by the user U and generates a sharing record for the friend or the group selected by the user U. The corresponding sharing record includes a sharing object and an application resource ID. Optionally, the sharing record may also include one or more of a title, a resource type, and an application ID.

After the foregoing process, the process for the user V to view the shared photo resource provided by the user U may specifically include:
(1) The user V logs in to sns.com and clicks a page for viewing a sharing message, and then the social platform looks for the sharing record generated for the user V, generates the sharing message and a corresponding message link according to the sharing record generated for the user V, and provides the sharing message and the message link to the user V through a corresponding page.

The process for generating the message link may include:

First, the social platform views the resource type and learns that the value of the resource type is 1, which indicates that the photo resource is a private resource, and therefore generates a platform processing URL link according to a mode for generating a private resource link, where the URL link regarded as the message link includes the application ID 123 and the resource ID parameter http://photo.com/viewPhoto.php?id=101; then, the social platform generates the sharing message, where the sharing message includes the URL link or further includes information such as the sharing object and a subject.
(2) The user V clicks the corresponding URL link regarded as the message link to view the shared photo resource provided by the user U.

In the process for the user V to view the shared photo resource provided by the user U, the social platform and the application website respectively need to adopt the following processes:

The specific operation process of the social platform may include:

First, obtain a sharing URL, http://photo.com/share.php, of the private resource (that is, the photo resource) of an application; calculate a valid time parameter t according to a current time t0, where it is assumed that t0 is 2008-11-0113:20:25 and t is 2008-11-0113:22:25, so the corresponding valid time parameter is denoted as 20081101132225; obtain an IP address p of a user terminal, which is 192.168.1.2; generate a random number n, which is 4311313512; and obtain the application key 1231234567 according to the application ID 123. For example, the application key corresponding to the application ID can be obtained through a corresponding application key table, where the application key table records mapping relation between the application ID and the application key.

Then, a character string S to be hashed is obtained by combining generated or obtained information, which is:
http://photo.com/viewPhoto.php?id=101:20081101132225: 4311313512:123: 1231234567: 192.168.1.2.

Then, calculate a hash value of S by adopting the MD5 algorithm, which is h=MD5(S)=4c848705a9f8463de1d494f2f5361eaa; and generate a security authentication parameter according to a value of h, which is

T=200811011322258&n=4311313512&A=1238&h=4c848705a9f8463de1d494f2f5361eaa.

Finally, generate the URL link for accessing the shared photo resource on the application website according to the security authentication parameter, and provide it to the user V. The URL link may be:
http://photo.com/share.php?r=http%3A%2F%2Fphoto.com%2FviewPhoto.php%3Fid% 3D101&T=200811011322258&n=4311313512&A=123&h=4c848705a9f8463de1d494f2f5361eaa.

The specific operation process of the application website is to verify the URL link when the social platform returns the URL link of the shared photo resource provided by the application website to the user V and when a user browser accesses the URL link, and may include:

First, obtain the IP address p1=192.168.1.2 of the user V, the current time t1=20081101132100, and the parameters r, t, and n in the URL, where r=http://photo.com/viewPhoto.php?id=101, t=20081101132225, n=4311313512.

Then, compare whether the current time is less than a value of the parameter t, and if the current time is less than the value of the parameter t, obtain the application ID a=123 and the application key k=1231234567, obtain a character string S1 to be hashed through combination, which is S1=http://photo.com/viewPhoto.php?id=101:20081101132225: 4311313512:123: 1231234567: 192.168.1.2, and calculate a hash value h1 of S1 by adopting the MD5 algorithm, which is h1=MD5(S1)=4c848705a9f8463de1d494f2f5361eaa.

Finally, compare whether a value of the calculated h1 is equal to a value of the parameter h; and if the calculate h1 is equal to the value of the parameter h, the verification succeeds, and the user V is allowed to access the shared photo resource provided by the user U.

In the process, if the application website determines that the current time is not less than the value of the parameter t or the value of the calculated h1 is not equal to the value of the parameter h, the application website forbids the user V to access the shared photo resource provided by the user U.

Through the technical solution provided by the embodiment of the present invention, the user on the user management device such as the social platform can securely share the shared resource with other users on the resource management device such as the application website, therefore providing the security capability to the cooperation between devices such as the application website and the social platform when providing users with services, so that when the user shares his/her resource on the application website, the user can restrict the access right of other users, therefore ensuring that the user has the capability of control over the private resource, and facilitating the secure resource sharing between the user and his/her friends.

Persons of ordinary skill in the art should understand that, all or a part of processes in the methods according to the embodiments may be implemented by a computer program instructing relevant hardware. The program may be stored in a computer-readable storage medium. When the program is executed, the processes of the methods are performed. The storage medium may be a magnetic disk, an optical disk, a read-only memory (ROM), or a random access memory (RAM).

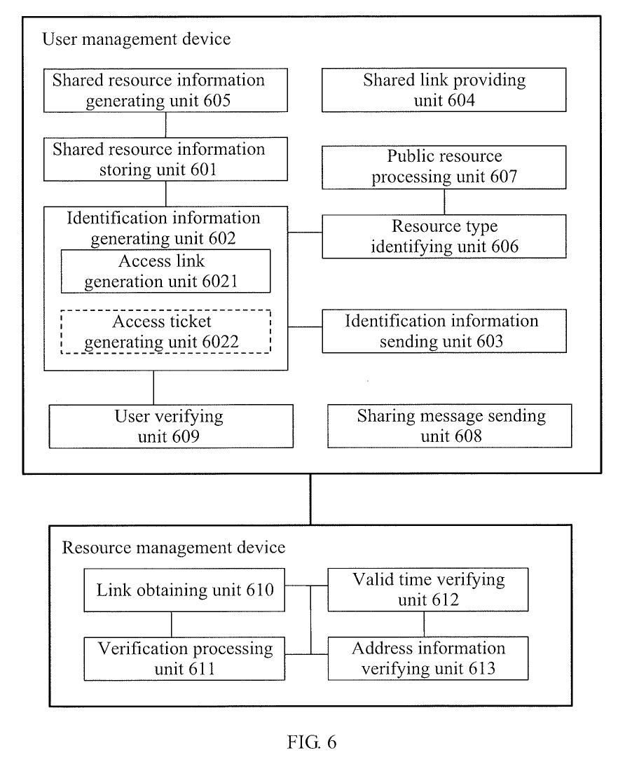

An embodiment of the present invention further provides a user management device, which may be a device such as a social platform. The specific structure of the user management device is shown in FIG. 6. The user management device may include a shared resource information storing unit 601, an identification information generating unit 602, and an identification information sending unit 603.

The shared resource information storing unit 601 is configured to save shared resource information shared by a shared resource provision user with a shared resource access user, where the shared resource information is used to identify the shared resource access user having a right to access a shared resource and the shared resource locally provided by the shared resource provision user.

The identification information generating unit 602 is configured to generate identification information for accessing the shared resource according to the shared resource information saved in the shared resource information storing unit 601 and an application key when the shared resource access user accesses the shared resource, where the shared resource access user is capable of accessing the shared resource on a resource management device according to the identification information for accessing the shared resource, and the resource management device is capable of verifying the identification information for accessing the shared resource by using the application key.

The identification information generating unit may be specifically any one of an access link generating unit 6021 and an access ticket generating unit 6022.

The access link generating unit 6021 is configured to generate a security authentication parameter according to the shared resource information saved in the shared resource information storing unit 601 and the application key and generate a link for accessing the shared resource according to the security authentication parameter as the identification information for accessing the shared resource.

The access ticket generating unit 6022 is configured to generate an access ticket according to the shared resource information saved in the shared resource information storing unit 601 and the application key as the identification information for accessing the shared resource, where the access ticket is a basis for the shared resource access user to generate the link for accessing the shared resource.

The corresponding link for accessing the shared resource may also include at least one of a valid time parameter for indicating valid time information of the link for accessing the shared resource and address information of the shared resource access user.

The identification information sending unit 603 is configured to send the identification information generated by the identification information generating unit 602 to the corresponding shared resource access user.

Optionally, the user management device may further include a sharing link providing unit 604 and a shared resource information generating unit 605.

The sharing link providing unit 604 is configured to provide the shared resource provision user with a sharing link or an application page in an iframe.

The shared resource information generating unit 605 is configured to obtain the shared resource access user selected by the shared resource provision user after the shared resource provision user accesses the user management device through the sharing link or the application page in the iframe provided by the sharing link providing unit 604, generate the shared resource information according to the shared resource access user selected by the user and the shared resource provided by the shared resource provision user for sharing, and provide the shared resource information to the shared resource information storing unit 601, where the user management device can specifically learn the shared resource provided by the shared resource provision user for sharing through the sharing link or the application page in the iframe adopted by the shared resource provision user.

Optionally, the user management device may further include a resource type identifying unit 606 and a public resource processing unit 607.

The resource type identifying unit 606 is configured to identify a resource type of the shared resource provided by the shared resource provision user in the resource management device.

The public resource processing unit 607 is configured to generate a link for directly accessing the shared resource and provide the link to the shared resource access user if the resource type identifying unit 606 identifies the shared resource as a public resource.

If the resource type identifying unit 606 identifies the shared resource as a private resource, the identification information generating unit 602 is notified of generating the identification information.

Optionally, the user management device may further include a sharing message sending unit 608 and a user verifying unit 609.

The sharing message sending unit 608 is configured to send a sharing message to the shared resource access user, where the sharing message includes a link for processing resource sharing pointed to the user management device.

The user verifying unit 609 is configured to verify the shared resource access user when the shared resource access user accesses the user management device through the link for processing the resource sharing and notify the identification information generating unit 602 of generating the identification information only after the verification succeeds.

Still referring to FIG. 6, an embodiment of the present invention further provides a resource management device, which may be a device such as an application website. A specific structure of the resource management device may include a link obtaining unit 610 and a verification processing unit 611.

The link obtaining unit 610 is configured to obtain a link for accessing shared resource sent by a shared resource access user, where the link for accessing the shared resource is determined according to identification information for accessing the shared resource, the identification information for accessing the shared resource is generated according to shared resource information and an application key, and the shared resource information is used to identify the shared resource access user having a right to access the shared resource and the shared resource provided by a shared resource provision user in the resource management device.

The verification processing unit 611 is configured to verify the link for accessing the shared resource obtained by the link obtaining unit 610, so as to effectively control the right for the shared resource access user to access the shared resource and ensure the security during resource sharing.

Optionally, the resource management device may further include at least one of a valid time verifying unit 612 and an address information verifying unit 613.

The valid time verifying unit 612 is configured to verify a valid time parameter for indicating valid time information of the link for accessing the shared resource included in the link for accessing the shared resource obtained by the link obtaining unit 610.

The address information verifying unit 613 is configured to verify address information of the shared resource access user included in the link for accessing the shared resource obtained by the link obtaining unit 610.

In the user management device and the resource management device, the specific processing modes that can be adopted by each processing unit during implementing the processing function are described in details and therefore are not described here again.

An embodiment of the present invention further provides a system for implementing resource sharing, in which a specific structure is still shown in FIG. 6 and includes the user management device and the resource management device.

Through the embodiments of the user management device, the resource management device, and the system composed of the user management device and the resource management device, a secure resource sharing service can be implemented for the user on the user management device, therefore ensuring that the user can effectively control the process for sharing the shared resource provided by the user. For example, only one or more users are allowed to share a resource, or only users in a group are allowed to share a resource.

Although the present invention is described above with some preferred embodiments, the scope of the present invention is not limited thereby. Modifications and variations that can be easily derived by persons skilled in the art without departing from the scope or spirit of the present invention shall fall within the protection scope of the present invention. Therefore, the protection scope of the invention is subject to the appended claims.

What is claimed is:

1. A method for implementing resource sharing, comprising:
saving shared resource information shared by a shared resource provision user with a shared resource access user in a user management device, wherein the shared resource information is used to identify the shared resource access user having a right to access a shared resource and the shared resource provided by the shared resource provision user in a resource management device; and
when the shared resource access user accesses the shared resource, generating, by the user management device, identification information for accessing the shared resource according to the shared resource information and an application key, and sending the identification information to the shared resource access user, wherein the shared resource access user is capable of accessing the shared resource on the resource management device according to the identification information for accessing the shared resource, and the resource management device is capable of verifying the identification information for accessing the shared resource by using the application key.

2. The method according to claim 1, wherein the saving of the shared resource information shared by the shared resource provision user with the shared resource access user comprises:
obtaining, by the user management device, the shared resource access user selected by the shared resource provision user after the shared resource provision user accesses the user management device through a sharing link or an application page in an iframe provided in the resource management device; and
generating the shared resource information according to the shared resource access user selected by the user and the shared resource provided by the shared resource provision user for sharing, and saving the shared resource information.

3. The method according to claim 1, wherein the shared resource information comprises:
an application identifier (ID) for identifying the resource management device, an application resource ID for identifying a resource, and shared resource access user information;
or
an application resource ID for identifying the resource and shared resource access user information.

4. The method according to claim 1 wherein the generating of the identification information for accessing the shared resource according to the shared resource information and the application key comprises:
generating a security authentication parameter according to the shared resource information and the application key, and generating a link for accessing the shared resource by using the security authentication parameter as the identification information for accessing the shared resource;
or
generating an access ticket according to the shared resource information and the application key as the identification information for accessing the shared resource, wherein the access ticket is a basis for the shared resource access user to generate the link for accessing the shared resource.

5. The method according to claim 4, wherein the link for accessing the shared resource further comprises at least one of:
a valid time parameter for indicating valid time information of the link for accessing the shared resource and address information of the shared resource access user.

6. The method according to claim 1 wherein the generating of the identification information for accessing the shared resource according to the shared resource information and the application key comprises:
identifying a resource type of the shared resource provided by the shared resource provision user in the resource management device, and if the shared resource is a public resource, generating a link for directly accessing the shared resource and providing the link to the shared resource access user; if the shared resource is a private resource, generating the identification information for accessing the shared resource according to the shared resource information and the application key.

7. The method according to claim 1 wherein the generating of the identification information for accessing the shared resource according to the shared resource information and the application key comprises:
sending, by the user management device, a sharing message to the shared resource access user, wherein the sharing message comprises a link for processing the resource sharing pointed to the user management device; and
when the shared resource access user accesses the user management device through the link for processing the resource sharing, verifying, by the user management device, the shared resource access user, and only after the verification succeeds, generating the identification information for accessing the shared resource according to the shared resource information and the application key.

8. A user management device, comprising:
a shared resource information storing unit, configured to save shared resource information shared by a shared resource provision user with a shared resource access user, wherein the shared resource information is used to identify the shared resource access user having a right to access a shared resource and the shared resource locally provided by the shared resource provision user;
an identification information generating unit, configured to generate identification information for accessing the shared resource according to the shared resource information saved in the shared resource information storing unit and an application key when the shared resource access user accesses the shared resource, wherein the shared resource access user is capable of accessing the shared resource on a resource management device according to the identification information for accessing the shared resource, and the resource management device is capable of verifying the identification information for accessing the shared resource by using the application key; and
an identification information sending unit, configured to send the identification information generated by the identification information generating unit to the shared resource access user.

9. The device according to claim 8, further comprising:
a sharing link providing unit, configured to provide the shared resource provision user with a sharing link or an application page in an iframe; and
a shared resource information generating unit, configured to obtain the shared resource access user selected by the shared resource provision user after the shared resource provision user accesses the user management device through the sharing link or the application page in the iframe provided by the sharing link providing unit, generate the shared resource information according to the shared resource access user selected by the user and the shared resource provided by the shared resource provision user for sharing, and provide the shared resource information to the shared resource information storing unit.

10. The device according to claim 9, wherein the identification information generating unit specifically comprises:
an access link generating unit, configured to generate a security authentication parameter according to the shared resource information saved in the shared resource information storing unit and the application key and generate a link for accessing the shared resource by using the security authentication parameter as the identification information for accessing the shared resource;
or
an access ticket generating unit, configured to generate an access ticket according to the shared resource information saved in the shared resource information storing unit and the application key as the identification information for accessing the shared resource, wherein the access ticket is a basis for the shared resource access user to generate a link for accessing the shared resource.

11. The device according to claim 10, wherein the link for accessing the shared resource further comprises at least one of:
a valid time parameter for indicating valid time information of the link for accessing the shared resource and address information of the shared resource access user.

12. The device according to claim 9, further comprising:
a resource type identifying unit, configured to identify a resource type of the shared resource provided by the shared resource provision user in the resource management device; and
a public resource processing unit, configured to generate a link for directly accessing the shared resource and provide the link to the shared resource access user if the resource type identifying unit identifies the shared resource as a public resource,
wherein if the resource type identifying unit identifies the shared resource as a private resource, the identification information generating unit is notified of generating the identification information.

13. The device according to claim 9, further comprising:
a sharing message sending unit, configured to send a sharing message to the shared resource access user, wherein the sharing message comprises a link for processing resource sharing pointed to the user management device; and
a user verifying unit, configured to verify the shared resource access user when the shared resource access user accesses the user management device through the link for processing the resource sharing and notify the identification information generating unit of generating the identification information only after the verification succeeds.

14. A method for implementing resource sharing, comprising:
obtaining, by a resource management device, a link for accessing shared resource sent by a shared resource access user, wherein the link for accessing the shared resource is determined according to identification information for accessing the shared resource, the identification information for accessing the shared resource is generated according to shared resource information and an application key, and the shared resource information is used to identify the shared resource access user having a right to access the shared resource and the shared resource provided by a shared resource provision user in the resource management device; and
verifying, by the resource management device, the link for accessing the shared resource according to the application key, so as to control the right for the shared resource access user to access the shared resource.

15. The method according to 14, further comprising:
if the link for accessing the shared resource further comprises at least one of a valid time parameter for indicating valid time information of the link for accessing the shared resource and address information of the shared resource access user, further performing, by the resource management device, verification according to the valid time parameter and the address information.

16. A resource management device, comprising:
a link obtaining unit, configured to obtain a link for accessing shared resource sent by a shared resource access user, wherein the link for accessing the shared resource is determined according to identification information for accessing the shared resource, the identification information for accessing the shared resource is generated according to shared resource information and an application key, and the shared resource information is used to identify the shared resource access user having a right to access the shared resource and the shared resource provided by a shared resource provision user in the resource management device; and
a verification processing unit, configured to verify the link for accessing the shared resource according to the application key obtained by the link obtaining unit, so as to control the right for the shared resource access user to access the shared resource.

17. The device according to claim 16, further comprising at least one of:
a valid time verifying unit, configured to verify a valid time parameter for indicating valid time information of the link for accessing the shared resource comprised in the link for accessing the shared resource obtained by the link obtaining unit; and
an address information verifying unit, configured to verify address information of the shared resource access user comprised in the link for accessing the shared resource obtained by the link obtaining unit.
